(19) United States
(12) Patent Application Publication
(10) Pub. No.: US 2009/0281863 A1
(43) Pub. Date: Nov. 12, 2009

(54) Systems and methods for determining utilization of facilities and interactions with campaigns

(76) Inventor: David Yaskin, Arlington, VA (US)

Correspondence Address: MCDERMOTT, WILL & EMERY, 11682 EL CAMINO REAL, SUITE 400, SAN DIEGO, CA, 92130-2047, US

(21) Appl. No.: 12/151,584

(22) Filed: May 6, 2008

(51) Int. Cl. G06Q 10/00

(52) U.S. Cl. 705/8

(57) ABSTRACT

Systems and methods are provided for electronically determining utilization of one or more facilities and interaction with campaigns. Personal interaction data may be captured, wherein the personal interaction data has one or more data elements, and relates to use of the facilities and interaction with campaigns. The captured personal interaction data elements may be correlated with the facilities and campaigns. The utilization of the facilities and interaction with campaigns may be based at least in part on the correlated personal interaction data. Resource allocation may be evaluated for each of the one or more facilities and campaigns based at least in part on the determined utilization. The system and methods may further comprise determining which personal interaction data elements have increased correlation with the one or more facilities and campaigns comprises applying factor analysis.

### FIELD

The present disclosure generally relates to computer software and hardware systems, and, in particular, relates to systems and methods for correlating factors with utilization of facilities and campaigns.

### BACKGROUND

Presently, educational institutions strive to build a campus that encourages learning both inside and outside the classroom, as well as foster personal growth. The physical campus, co-curricular activities, extra-curricular activities, campus computer networks that foster on-line communities, and other services typically contribute to the experiences of persons associated with an educational institution. Educational institutions endeavor to offer many academic programs, as well as create a diverse student experience as part of a holistic approach to education. Educational institutions seek to enrich not only the experiences of students, but those of faculty, staff, alumni, and members of the community as well.

Educational institutions, however, find it difficult to determine which persons associated with an educational institution utilize facilities and take part in campaign events. Facilities can include physical space, but can also include resources (e.g., computing systems and networks, printers, etc.), inventoried items (e.g., books in the library), or consumables (e.g., food, etc.). Campaigns can be educational programs or activities related to art, music, health and wellness, or other topics. Campaigns not only include educational related programs and activities, but are social, cultural and other types of programs and activities.

It is also difficult for an educational institution to determine the frequency or amount of utilization of campaigns and facilities. Knowing which facilities and campaigns are utilized is helpful for administrators in determining resource allocation for present and future facilities and campaigns. Investments in well-utilized facilities and in successful campaigns are often desirable in fostering an environment to attract and retain students, faculty, or staff, or encourage members of the community to interact with the educational institution.

It is desirable for an educational institution to determine which facilities are utilized and which campaigns are well received (i.e., campaign events attended, money raised, etc.) by correlating captured personal interactions with facilities, campaigns or both to determine utilization. It is further desirable to evaluate resource allocation for one or more facilities or campaigns. Accordingly, there exists a need for systems and methods to correlate captured personal interaction data with utilization of facilities and with campaigns.

### SUMMARY

The disclosure provides systems and methods for determining utilization of facilities and the success of campaigns for an educational institution. Facilities may include, for example, physical space, but may also include resources (e.g., computing systems and networks, printers, etc.), inventoried items (e.g., books in the library), or consumables (e.g., food, etc.). Campaigns may be, for example educational programs or activities related to art, music, health and wellness, etc. Categorical hierarchies may be configured to enable processing of facilities utilization and of campaign data. Categories may include, for example, cultural events and athletic events, where cultural events may be further hierarchically categorized as lecture events (i.e., lectures outside of class), or as fee-based events (as opposed to free events), or any other suitable categorization. Non-hierarchical categorization is also provided in certain embodiments, which includes the use of tagging.

The disclosed embodiments correlate captured data, from a card swipe for example, to a campaign at the institution to determine how the campaign impacts outcomes for specific demographic groups. Attendance at a given time and place is captured and tracked to an event. The tracked attendance can be categorized in different ways. The disclosed embodiments interface event planning systems, card reading or other data capture systems, and outcome assessment systems with each other.

The systems and methods may determine utilization of facilities and the participation in campaign activities and track utilization changes over a predefined time period. A user identification card, electronic device (e.g., a portable electronic device), and/or universal account indicating personal identification information may be associated with an individual (e.g., a student, faculty member, staff member, administrator, alumni, part-time student, continuing education student, community member, or any other suitable person with an affiliation to an educational institution). The card or device may be swiped, read by a proximity reader, engaged in an interchange of information based on a received request, or be subject to any other registration by the system. This swiping or interchange of information may be used to track, for example, entry and exit into building facilities, attendance at events (e.g., arts and cultural events, sporting events, health and wellness events, etc.), or other activity. Determining utilization of facilities (e.g., student center, etc.) and campaign events may be periodically evaluated to determine whether monetary, staff, or other resources may be redistributed to more closely correlate with measured demand (i.e., utilization) of these facilities and the involvement in campaigns, as well as to promote institutional goals (e.g., which may be achieved by the implementation of one or more campaigns). Accordingly, personal characteristics (e.g., race, major field of study, grade point average, etc.) may be correlated with one or more activities, wherein the activities are planned based on, for example, available facilities and department sponsorship of activities. Card swiping systems, event registration systems, or other data entry systems may at least in part be used to measure the utilization of resources. The system and methods disclosed herein promote educational institutional effectiveness via resource optimization and reduction in inefficient spending. The systems and methods may also enhance successful revenue-generating programs (e.g., athletics), as well as enhance successful non revenue-generating programs (e.g., health services).

Systems and methods are provided for electronically determining utilization of one or more facilities and interaction with campaigns. The systems and methods comprise capturing personal interaction data, wherein the personal interaction data has one or more data elements and relates to use of the one or more facilities and interaction with campaigns. The systems and methods also comprise correlating the personal interaction data elements with the one or more facilities and campaigns. The systems and methods determine the utilization of the one or more facilities and interaction with campaigns based at least in part on the correlated personal interaction data elements.

The capturing of data by interfacing with applications and related databases may include both internal systems (i.e., those systems within the institution) and external systems. Examples of external systems include activity centers not directly related to the educational institution, but which interfaces with the institution. A fine arts theater, for example, may interface with the educational institution, and attendance at a recital may be captured. This is but one example, as other external systems can connect and interface with the system of the present invention.

The personal interaction data captured by the systems and methods may comprise facilities utilization data, campaign utilization data, or any combination thereof. The facilities utilization data may indicate athletic facilities utilization, laboratory facilities utilization, dining facilities utilization, research facilities utilization, recreational facilities utilization, classroom facilities utilization, computing facilities utilization, performance space facilities utilization, clinical facilities utilization, radio broadcast facilities utilization, television studio and broadcast facilities utilization, art studio facilities utilization, dormitory facilities utilization, parking facilities utilization, retail facilities utilization, entertainment facilities utilization, library facilities utilization, or student center facilities utilization, or any combination thereof. The campaign utilization data may indicate cultural campaign utilization, athletic campaign utilization, educational campaign utilization, health and wellness campaign utilization, nutrition campaign utilization, finance campaign utilization, community service campaign utilization, alumni relations campaign utilization, prospective student campaign utilization, current student campaign utilization, transfer student campaign utilization, continuing education campaign utilization, non-traditional student campaign utilization, faculty and staff campaign utilization, parents and friends campaign utilization, emergency preparedness campaign utilization, administration campaign utilization, or business partner campaign utilization, or any combination thereof.

The system and methods may further comprise determining the utilization of the one or more facilities and interaction with campaigns based at least in part on the correlated personal interaction data elements to the facilities or campaigns by applying factor analysis.

Systems and methods are provided for electronically determining resource allocation from student interactions. The systems and methods comprise capturing student interaction data, wherein the student interaction data has one or more data elements, and correlating the student interaction data elements with one or more facilities and interaction with campaigns. The systems and methods further comprise determining student usage of the one or more facilities and interaction with campaigns based on the correlated student interaction data elements. The systems and methods further comprise evaluating the resource allocation for each of the one or more facilities and interactions with campaigns based at least in part on the determined student usage.

Additional features will be set forth in the description below, and in part will be apparent from the description, or may be learned by practice of the exemplary embodiments. The exemplary embodiments will be realized and attained by the structure particularly pointed out in the written description and claims hereof as well as the appended drawings.

It is to be understood that both the foregoing general description and the following detailed description are exemplary and explanatory and are intended to provide further explanation of the claims.

### BRIEF DESCRIPTION OF THE DRAWINGS

The accompanying drawings, which are included to provide further understanding of the exemplary embodiments and are incorporated in and constitute a part of this specification, illustrate embodiments and together with the description serve to explain the embodiments. In the drawings:

FIG. 1 illustrates an exemplary block-level diagram of an educational institutional environment in which a facilities utilization and campaign interaction system is implemented according to an exemplary embodiment;

FIG. 2 is a flow diagram for correlating personal interaction data with one or more facilities and interaction with campaigns according to an exemplary embodiment;

FIG. 3 illustrates a display that enables a user to view and access educational institution personal information regarding students, faculty, staff, and administration, as well as facilities utilization and campaign interaction according to an exemplary embodiment;

FIG. 4 depicts a display indicating facilities utilization and resource allocation for facilities according to an exemplary embodiment;

FIG. 5 illustrates a graphical display indicating facilities utilization based on captured personal interaction data according to an exemplary embodiment;

FIGS. 6-7 depict displays indicating resource allocation and utilization of athletic facilities according to an exemplary embodiment;

FIG. 8 depicts a display indicating selectable campaign categories according to an exemplary embodiment; and

FIGS. 9-10 illustrate displays indicating utilization of cultural event campaigns according to an exemplary embodiment.

### DETAILED DESCRIPTION

In the following detailed description, numerous specific details are set forth to provide a full understanding of the exemplary embodiments. It will be obvious, however, to one ordinarily skilled in the art that the embodiments may be practiced without some of these specific details. In other instances, well-known structures and techniques have not been shown in detail so as not to obscure the embodiments.

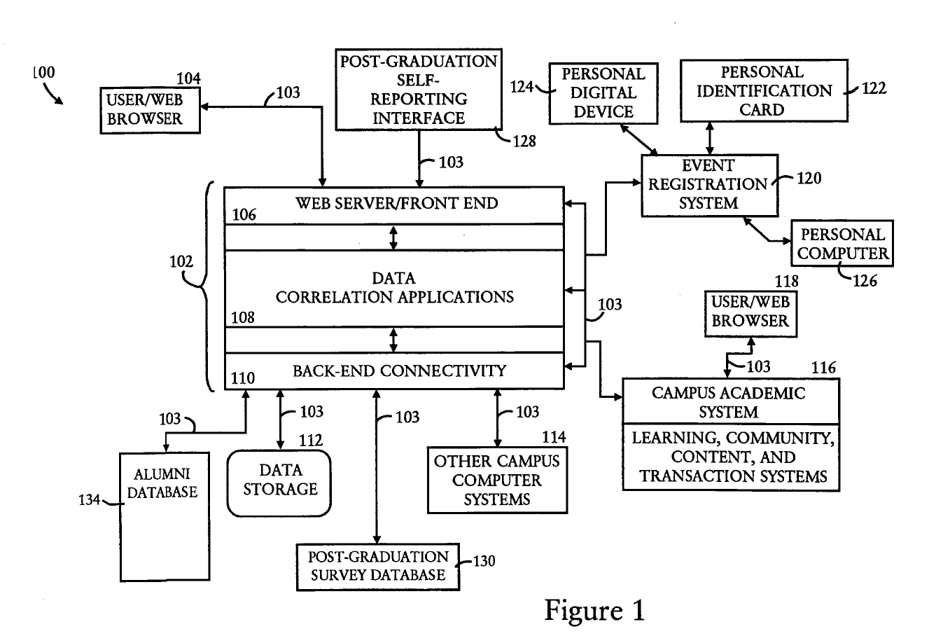

FIG. 1 depicts a functional block diagram of an exemplary data correlation system 100. As described in more detail herein, data correlation system 100 may provide a framework for determining utilization of facilities by students, faculty, staff, and other persons in, for example, an educational institution. Computing system 102 may be one or more computers (e.g., one or more servers, personal computers, minicomputers, mainframe computers, or any other suitable computing devices, or any combination thereof) that may be configured with front-end 106, data correlation applications 108, and back-end connectivity 110.

User computer 104 may be configured to communicate with computer system 102 via a web browser or similar interface to communicate with an appropriately configured front-end 106 of system 102. Communication between user computer 104 and front end 106 of computer system 102 may be via communications link 103, which may be a wireless or wired communications link such as a local area network, wide area network, the Internet, or any other suitable communications network. Front-end 106 may be, for example, a web server or other computing device hosting one or more data correlation applications 108 that user computer 104 may access. Applications 108 may be one or more software components or programs that execute on a programmable computer platform of computer system 102 to provide functionality related to correlating personal interaction data with facilities and campaigns. Such applications 108 may include components for capturing personal interaction data, and determining which captured personal interaction data elements have increased correlation with facilities and campaigns. Applications 108 may determine the utilization of facilities and campaigns from the correlated personal interaction data. Applications 108 may further evaluate resource allocation for one or more of the facilities and campaigns based at least in part on the determined utilization.

Computing system 102 may also access data storage facilities 112 and other computer systems 114 via communications link 103. For example, data storage facilities 112 may be one or more digital data storage devices configured with one or more databases having student data (e.g., student identification number, student name, student gender, student race, courses completed, courses enrolled in, degree program, certificate program, etc.) and may also contain data received from a registration event with a student identification card, device configured with student information, and/or from registering an event by which a student entered identification data (e.g., a login event to a educational institution computer network application using student identification information). Data storage facilities 112 may store and arrange data in a convenient and appropriate manner for manipulation and retrieval. Data storage facilities 112 may be external to the computer system 102, or be part of the compute system 102. Other computer systems 114 may be a variety of third-party systems that contain data or resources that are useful for the data correlation system 100. In the exemplary higher education environment, systems 114 may include a student information system (SIS) that maintains student demographic information. Systems 114 may also include an electronically maintained class or course schedule for the institution that includes information about the courses such as section numbers, professors, class size, department, college, the students enrolled, etc. Other campus-related systems such as financial aid and the bursar's office may be included in systems 114 of FIG. 1.

Back-end connectivity 110 of computer system 102 may be appropriately configured software and hardware that interface between data correlation applications 108 and resources including, but not limited to, data storage 112 and other computer systems 114 via communications link 103.

Another resource to which the back end 110 may provide connectivity (e.g., via communications link 103) is a campus (or institutional) academic system 116. Campus academic system 116, in an academic environment, provides a platform that allows students and teachers to interact in a virtual environment based on the courses for which the student is enrolled. This system may be logically separated into different components such as a learning system, a content system, a community system, or a transaction system, or any other suitable system, or any combination thereof. For example, a student, administrator, faculty or staff member may operate user computer 118 to access academic system 116 via a web browser or similar interface.

Of particular usefulness to system 100, academic system 116 may provide a virtual space that user computer 118 may access to receive information and to provide information. One exemplary arrangement provides user computer 118 with a webpage where general information may be located and that has links to access course-specific pages where course-specific information is located. Electronic messaging, electronic drop boxes, and executable modules may be provided within the user's virtual space on the academic system 116. Thus, with respect to computer system 102, one of applications 108 may be used to generate information that is to be deployed to one or more users of academic system 116. Via back-end 110, the information may be sent to academic system 116 where it is made available to user computer 118 just as any other information may be made available. Similarly, from within the academic system 116, the user may enter and submit data that is routed through the back end 110 to one of the applications 108. Academic system 116 and computer system 102 may be more closely integrated so that the connectivity between the applications 108 and the system 116 is achieved without a network connection or back end software 110.

System 102 may be communicatively coupled to one or more registration systems 120, which may be a card reader, proximity reader, or other suitable system configured to capture information from personal identification card 122, personal digital device 124 (e.g., cellular phone, personal digital assistant, handheld computing device, laptop computer, etc.), or personal computer 126. Personal identification card 122, personal digital device 124, or personal computer 126 may be associated with a student, faculty member, staff member, administrator, alumni, part-time student, continuing education student, community member, or any other suitable person with an affiliation to an educational institution. Although only one personal identification card 122, personal digital device 124, and computer 126 are shown, there may be one or more of each respective device that may communicate with registration system 120. Identification card 122, digital device 124, and/or computer 126 may be configured with student identification information (e.g., student name, student identification number, gender, race, major, dining services plan, etc.). For example, personal identification card 122 may be swiped, scanned, or registered by proximity by registration system 120 at an event (e.g., student attending class, cultural event, entertainment event, athletic event, etc.) to capture and associate attendance by the student at the particular event. In another example, personal identification card 122 may be swiped, scanned, or registered by proximity by registration system 120 at the entrance or exit of a particular facility (e.g., student union, dormitory, library, athletic facility, etc.). Alternatively, personal digital device 124 may communicate student identification information via a wired or wireless communications link with registration system 120 at an event. Also, personal computer 126 may communicate with registration system 120 to provide student information at a login event or other information exchange event (e.g., electronic homework assignment submission by a student, wherein registration system captures the student identification information, as well as one or more data elements regarding the course and the assignment submission, etc.). Data captured by registration system 120 may be transmitted to computer system 102 via communications link 103 for processing (e.g., by applications 108, etc.) and/or storage (e.g., stored in data storage 112, etc.).

Data may be captured from student identification card 122 or student digital device 124 related to presence, utilizations, and transactions by a student. For example, a student may use card 122 or device 124 to purchase a ticket for a concert for the city symphony or a ticket for an exhibit at the city art museum. Card 122 or device 124 may be enabled with banking account, declining balance account, or credit card account information, or other financial transaction enabling information to facilitate the purchase of the tickets. Additionally, attendance of the symphonic concert or art museum exhibit by the student may be registered by registration system 120, which may be present at the city symphonic hall where the concert is being performed or at the art museum in order to receive student identification data and event information data (e.g., concert information, location of symphony hall, time of attendance, etc.) from the swiping or registering of student identification card 122 or device 124.

In another example, a student may use card 122 or device 124 to purchase admission to a conference. Again, card 122 or device 124 may also be enabled with banking account, declining balance account, or credit card account information, or other financial transaction enabling information to facilitate the purchase of the conference admission.

In yet another example, a student may use card 122 or device 124 to purchase a beverage at a musical event. During the purchasing transaction, card 122 may be swiped or read by a proximity reader (e.g., event registration system 120), and data may be captured such as the identity of the student, the location of the purchase (e.g., name and location of off-campus vendor), and data related to the items that were purchased (type of beverage, time of purchase, etc). Card 122 or device 124 may also be enabled with banking account, declining balance account, or credit card account information, or other financial transaction enabling information to facilitate the purchase of the items. In another example, student computer 126 may be used in an on-line purchasing transaction with an on-line merchant, wherein the student identification, identification information related to the items purchased, and information related to the on-line vendor may be captured by event registration system 120 (e.g., student computer 126 may transmit the information to event registration system 120 after the transaction).

In another example, computer 126 may be used in an on-line purchasing transaction with an on-line merchant, wherein the student identification, information related to the items purchased, and information related to the on-line vendor may be captured by event registration system 120 (e.g., computer 126 may transmit the information to event registration system 120 after the transaction).

Event registration system 120 may capture presence and utilization data by capturing data from personal identification card 122, digital data device 124, and/or computer 126 at particular events. For example, card 122 may be scanned (e.g., using event registration system 120) at the entrance of the educational institution's library (e.g., card 122 may be scanned at the entrance and exit of the library to record the times associated with entering and leaving), and may be scanned again when a student checks out a book. Thus, event registration system 120 may capture data related to the identity of the student, as well as the duration of time that the student was in the library, and information related to the book that the student checked out (e.g., author, title, genre, etc.). Similar registration of card 122 or device 124 by event registration system 120 may occur, for example, if the student, faculty member, staff member, administrator, or other person attends a sporting event (e.g., a football game, etc.) or a cultural event such as a music concert (e.g., concert by string quartet, chamber orchestra, jazz band, etc.).

In another example, event registration system 120 may capture presence and utilization data by capturing data from personal identification card 122, digital data device 124, and/or computer 126 when the student, faculty member, staff member, administrator, or other person associated with the educational institution utilizes the health clinic, counseling service, tutoring services, or other support services offered by the educational institution. Capturing the personal information of the student, faculty member, staff member, administrator, or other person may enable system 100 to determine utilization of these services, which may in turn aid with resource allocation for these services by administrators.

Post-graduation self-reporting interface 128 may be configured on a computing device (e.g., personal computer, laptop computer, personal digital assistant, cell phone, etc.) or may be accessed from front end 106 of computer system 102 by a computing device via a web browser. Post-graduation self-reporting interface 128 may enable a user (e.g., former student) to provide data related to post-graduation events including, but not limited to: graduate school entrance exams taken (e.g., Graduate Record Examination (GRE), Law School Admission Test (LSAT), Medical College Admission Test (MCAT), Graduate Management Admission Test (GMAT), etc.); graduate school entrance exam score(s) received; graduate school(s) applied to; graduate school(s) accepted to; graduate school(s) attended; graduate degree(s) granted; professional license(s) obtained; employers during the post-graduation period; employment positions held post-graduation; salaries received post-graduation; period of time to find employment post-graduation; current home address; or any other suitable information. Post-graduation information collection may relate to interaction with campaigns, where an educational institution may have one or more campaigns directed towards graduate school exam preparation, graduate school admission, and post-graduation employment. In order to determine the effectiveness of such campaigns, it is desirable to capture post-graduation information from previous students of an educational institution.

Computer system 102 may capture personal interaction data by interfacing with databases such as post-graduation database 130 and/or applications accessible via communications link 103. Database 130 may contain data captured via one or more surveys, wherein the data may be related to post-graduation events, including, but not limited to: graduate school entrance exams taken (e.g., GRE, LSAT, MCAT, GMAT, etc.); graduate school entrance exam score(s) received; graduate school(s) applied to; graduate schools accepted to; graduate school(s) attended; graduate degree(s) granted; professional license(s) obtained; employers during the post-graduate period; employment positions held post-graduation; salaries received post-graduation; period of time to find employment pos-graduation; current home address; or any other suitable information.

Alumni database 134 may be configured to store alumni information on one or more digital storage devices that enable alumni data to be readily accessible and/or searchable by a user (e.g., an administrator using computer 104 or 118, etc.). Alumni information may include, but is not limited to: name, address, school or college within the educational institution, major, year of graduation, phone number, email address, or any other suitable information. Alumni information in alumni database 134 may be obtained from post-graduation self-reporting interface 128, post-graduation survey database 130, event registration system 120, user computers 104 or 118, data storage 112, or any other part of system 100 via communications link 103.

Although front end 106, applications 108, and back end 110 of the computer system 102 are each depicted as a single block in FIG. 1, one of ordinary skill will appreciate that each may also be implemented using a number of discrete, interconnected components. As for the communication links between the various blocks of FIG. 1, a variety of functionally equivalent arrangements may be utilized. For example, some links may be via the Internet or other wide-area network, while other links may be via a local-area network or even a wireless interface. Also, although only a single computer 104 of computer system 102 is explicitly shown, multiple users and multiple computers or computing devices may be utilized in system 100. The structure of FIG. 1 is logical in nature and does not necessarily reflect the physical structure of such a system. For example, computer system 102 may be distributed across multiple computer platforms as can the data storage 112. Furthermore, components 106, 108, 110 are separate in the figure to simplify explanation of their respective operation. However, these functions may be performed by a number of different, individual components, or a more monolithically arranged component. Additionally, any of the three logical components 106, 108, 110 may directly communicate with the academic system 116 without an intermediary. Also, although the users 104, 118 are depicted as separate entities in FIG. 1, they may, in fact, be the same user or a single web browser instance concurrently accessing both computer system 102 and the academic system 116.

Correlating personal interaction data with facilities and campaigns is a complex undertaking that encompasses many different levels of data collection and analysis. System 100 may be used to capture personal interaction data from one or more sources from participation in activities and utilization of resources at an educational institution, capture personal interaction via surveys or self-reporting systems, and correlate the personal interaction data with facilities and campaigns to determine utilization. Resource allocation for the one or more facilities and campaigns may be evaluated based on the determined utilization.

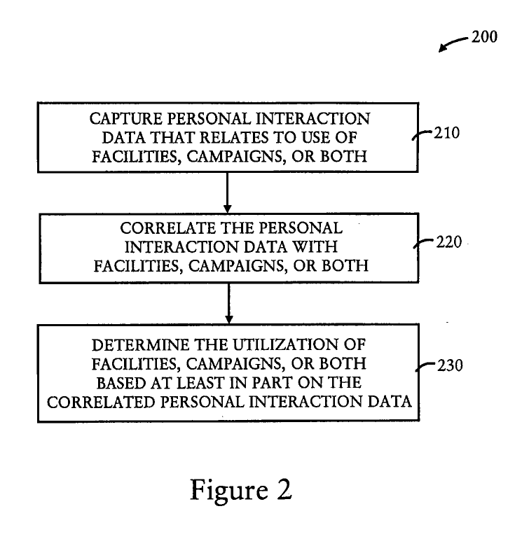

FIG. 2 depicts an exemplary diagram for flow 200 for correlating personal interaction data element with one or more facilities and campaigns. Computer system 102 (FIG. 1) configured with data correlation applications 108 may, for example, perform flow 200. At block 210, at least some personal interaction data may be captured, where the captured data has one or more elements. The personal interaction data may be interaction data related to students, faculty, staff, alumni, or any other suitable interaction data captured from an individual that may be associated with an educational institution.

For example, system 100 may capture data (e.g., using registration system 120) related to personal interaction data. The captured personal interaction data may relate to, for example, how frequently a person (e.g., student, alumni, faculty member, staff member, etc.) has attended class, visited the library, utilized entertainment offerings on- or off-site from an educational campus, participated in educational online organizations, attended educational events or lectures outside of class, patronage of on-campus merchants, patronage of off-campus merchants, patronage of on-line merchants, electronic submission of an assignment or other document, or electronic submission of personal identification information, utilization of an on-campus resource (e.g., checking out a library book, usage of a computer lab or athletic facility, etc.), utilization of an off-campus resource (e.g., utilization of public transportation, off-campus concert hall, off-campus art museum, etc.), or any transactional or utilization information, or any combination thereof.

Also, the captured data may also include personal data that may be requested and received by computer system 120 from various sources in system 100 (e.g., from campus academic system 116, data storage 112, and/or campus computer system 114 of FIG. 1). Personal data may include, but is not limited to personal demographic data, student degree program, student certificate program, courses completed, course type (e.g., on-line courses, distance learning courses, on-campus courses, summer courses, continuing education courses, etc.), courses needed for completion of the degree or certificate program, faculty department, staff department, or any other suitable information, or any combination thereof. The personal data may be stored, for example in data storage 112, other campus computer 114, campus academic system 116, or any other suitable digital storage device communicatively coupled to computer system 102.

Also at block 210, system 100 may capture personal interaction data from post-graduation self-reporting interface 128 and/or from post-graduation database 130. Additionally, personal interaction data may also be captured by event registration system 120. For example, a former student may continue to participate in on-line forums, and the former student's participation may be captured by event registration system 120 (e.g., student identifying information may indicate the student's participation in the forum), or a former student may continue to attend cultural events on- or off-campus (e.g., former student may have retained card 122 or device 124 which may be registered by event registration system 120, or the former student may be issued an alumni version of card 122 or device 124). Personal interaction data may also include graduate school entrance exam results, graduate schools accepted to, graduate schools that declined acceptance, graduate degrees obtained, professional licenses obtained, employer names and locations, employment positions held, salaries, any other suitable data, or any combination thereof.

At block 220, system 100 may correlate at least some of the captured personal interaction data with one or more facilities, campaigns, or both. For example, computer system 102 of system 100 may correlate at least some of the captured personal interaction data by applying factor analysis, as described in further detail below, to determine which personal interaction data elements have increased correlation with the one or more facilities and campaigns. For example, students of a particular major may have increased correlation with use of a facility (e.g., student union, athletic facility, etc.), or may have increased correlation with a campaign event (e.g., increased attendance of cultural events as part of an educational institution's cultural campaign, etc.).

The correlation may be made between event usage, campaign involvement, facility usage, and a range of outcomes and measures that may be provided. Among the outcomes that may be provided are survey results, measuring student satisfaction, for example. Another outcome can be learning outcomes achievement. The outcomes that can be correlated to event usage, campaign involvement and facility usage may include those related to current students, as well as alumni. For example, the outcomes may be post-graduation outcomes, such as alumni giving, or alumni mentoring.

At block 230, computer system 102 of system 100 may determine the utilization of facilities, campaigns, or both based at least in part on the correlated personal interaction data. System 102 may apply factor analysis, as described below, in order to determine which personal interaction data elements have an increased correlation with the facilities and campaigns. Additionally, after block 230, flow 200 may include computer system 102 evaluating resource allocation for each of the facilities and campaigns based at least in part on the determined utilization. Computer system 102 may apply factor analysis, as described below, to determine which resources or what amount of resources should be reallocated based on the determined utilization of facilities and campaigns. For example, computer system 102 may provide recommendations to increase the resources allocated to a facility that was determined to have increased utilization, or a campaign that was successful or had increased involvement. In another example, computer system 102 may recommend that additional resources be allocated to a campaign that has been determined to have comparatively low levels of involvement. The increased allocation of resources may improve or promote the particular campaign so as to meet an educational institution's goals.

Factor analysis may be used by the exemplary systems described herein (e.g., system 100 of FIG. 1) as a statistical data reduction technique that may be used to explain variability among observed random variables in terms of fewer unobserved random variables (i.e., factors). The observed variables may be modeled as linear combinations of the factors. An advantage of factor analysis is the reduction of the number of variables by combining two or more variables into a single factor. Accordingly, factor analysis may be used for data reduction. For example, specific factors may be combined into a general, overarching factor such as academic performance. Another advantage of factor analysis is the identification of groups of inter-related variables to determine how they are related to each other. Thus, factor analysis may also be used as a structure detection technique. For example, student attendance of cultural events (e.g., music concert, dance recital, art exhibit, film festival, etc.) may relate to interaction with one or more campaigns of an educational institution (e.g., a campaign to promote cultural activities as part of a student experience), and may also relate to utilization of facilities (e.g., concert hall, dance facility, entertainment complex, etc.).

Correspondence analysis also may be performed by the exemplary systems as described herein. Correspondence analysis may be used, for example, to analyze two-way and multi-way tables containing one or more measures of correspondence between data (i.e., data in the rows and columns of the table). The results may provide information which is similar in nature to those produced by factor analysis techniques. The structure of categorical variables included in the table may be identified and summarized for presentation to a user (e.g., administrator, faculty member, etc.).

In using factor analysis as a variable reduction technique, the correlation between two or more variables may be summarized by combining two variables into a single factor. For example, two variables may be plotted in a scatterplot. A regression line may be fitted (e.g., by computer system 102 of FIG. 1) that represents a summary of the linear relationships between the two variables. For example, if there are two variables, a two-dimensional plot may be performed, where the two variables define a plane. With three variables, a three-dimensional scatterplot may be determined, and a plane could be fitted through the data. With more than three variables it becomes difficult to illustrate the points in a scatterplot, but the analysis may be performed by computer system 102 to determine the regression summary of the relationships between the three or more variables. A variable may be defined that approximates the regression line in such a plot to capture the principal components of the two or more items. Data scores from student data on the new factor (i.e., represented by the regression line) may be used in future data analyses to represent that essence of the two or more items. Accordingly, two or more variables may be reduced to one factor, wherein the factor is a linear combination of the two or more variables.

The extraction of principal components may be found by determining a variance maximizing rotation of the original variable space. For example, in a scatterplot, the regression line may be the original X-axis, rotated so that it approximates the regression line. This type of rotation is called variance maximizing because the criterion for (i.e., goal of) the rotation is to maximize the variance (i.e., variability) of the “new” variable (factor), while minimizing the variance around the new variable. Although it is difficult to perform a scatterplot with three or more variables, the logic of rotating the axes so as to maximize the variance of the new factor remains the same.

After a line has been determined on which the variance is maximal, some variability remains around this first line. Upon extraction of the first factor (i.e., after the first line has been drawn through the data), another line may be defined that maximizes the remaining variability. In this manner, consecutive factors may be extracted. Because each consecutive factor is defined to maximize the variability that is not captured by the preceding factor, consecutive factors are independent of each other. Thus, consecutive factors are uncorrelated or orthogonal to each other.

In applying principal component analysis as a data reduction method (i.e., a method for reducing the number of variables), the number of factors desired to be extracted may be selected. As consecutive factors are extracted, the factors may account for decreasing variability. One method to determine when to stop extracting factors may depend on when the “random” variability has significantly decreased (i.e., very little random variability left). A correlation matrix may be used to determine the variance amongst each of the variables. The total variance in that matrix may be equal to the number of variables.

In contrast to the variable reduction methods of principal component analysis described above, principal factor analysis may also be performed by computer system 102 of FIG. 1 to determine the structure in the relationships between variables. The personal interaction data may be used to form a “model” for principal factor analysis. For example, the personal interaction data may be dependent on at least two components. First, there may be one or more underlying common factors. Each item may measure some part of this common aspect. Second, each item may also capture a unique aspect (of the common aspect) that may not be addressed by any other item.

If this model is correct, the factors may not extract substantially all variance from the items. Rather, only that proportion that is due to the common factors and shared by several items may be extracted. The proportion of variance of a particular item that is due to common factors (shared with other items) is called communality. The communalities for each variable may be estimated (i.e., the proportion of variance that each item has in common with other items). The proportion of variance that is unique to each item may then the respective item's total variance minus the communality. A common starting point is to use the squared multiple correlation of an item with all other items as an estimate of the communality. Alternatively, various iterative post-solution improvements may be made to the initial multiple regression communality estimate.

A characteristic that distinguishes between the two factor analytic models described above is that in principal components analysis (i.e., factor reduction) may assume that substantially all variability in an item should be used in the analysis, while principal factors analysis (i.e., structure detection) may use the variability in an item that it has in common with the other items. In most cases, these two methods usually yield very similar results. However, principal components analysis is often preferred as a method for data reduction, while principal factors analysis is often preferred when the goal of the analysis is to detect structure.

Computer system 102 of FIG. 1 configured with factor analysis applications programming (e.g., as part of applications 108) may identify which personal interaction data elements have increased significance with utilization of facilities and interaction with campaigns. System 102 may use quantitative techniques, such as data gathering from registration system 120 (e.g., swipes of personal identification card 122, proximity readings of card 122, registration of digital device 124 configured with personal information, capturing personal identification information entered from computer 126, capturing data from post-graduation self-reporting interface 128, capturing data from post-graduation student survey database 130, etc.) to collect data about a person (e.g., student, faculty member, staff member, administrator, etc.) concerning their attendance and participation in various events or utilization of resources (e.g., use of facilities) or interaction with campaigns. The captured data (taken alone or in combination with other personal data that may be stored, e.g., with campus academic system 116) may be used as input for a statistical application (e.g., applications 108) of computer system 102 of FIG. 1, which may process the data using factor analysis. System 102 may yield a set of underlying attributes (i.e., factors). Upon determination of the factors, system 102 may construct perceptual maps, graphs, or other textual or visual output to indicate the correlation of particular personal interaction data elements and utilization of facilities and/or interaction with campaigns of an educational institution. System 102 may present such maps, graphs, and/or text in displays for presentation to, for example, an administrator, a faculty member, or any other suitable person using computer 104 or 118. System 102 may also provide recommendations on the allocation of resources to facilities and/of campaigns based at least in part on the determined utilization of the facilities or the interaction with campaigns.

Computer system 102 may be configured with programming that is executed to perform factor analysis on one or more elements of data to isolate underlying factors that summarize the resultant information as it relates to utilization of facilities and/or the interaction with campaigns. The factor analysis may be an interdependence technique, wherein one or more sets of interdependent relationships may be examined. The factor analysis may reduce the rating data on different attributes to a few important dimensions (e.g., the frequency or amount that a facility was utilized, to what extent campaigns had been participated in and campaign goals met, etc.). This reduction is possible because the attributes are related (e.g., the post-graduation student data relates to the post-graduation student outcome; the pre-graduation student interaction data relates to the achievement of post-graduation student outcomes, etc.). The rating given to any one attribute is partially the result of the influence of other attributes. Thus, system 102 may determine which facilities utilized by a person (e.g., student, faculty member, staff member, administrator, community member, etc.) and the amount of interaction with a campaign. System 102 may also provide recommendations as to resource allocation based at least in part on the determined utilization data. The statistical programming (e.g., application 108) implemented on system 102 may deconstruct the rating (i.e., raw score) into one or more components, and reconstruct the partial scores into underlying factor scores. The amount of correlation between the initial raw score and the final factor score is referred to as factor loading.

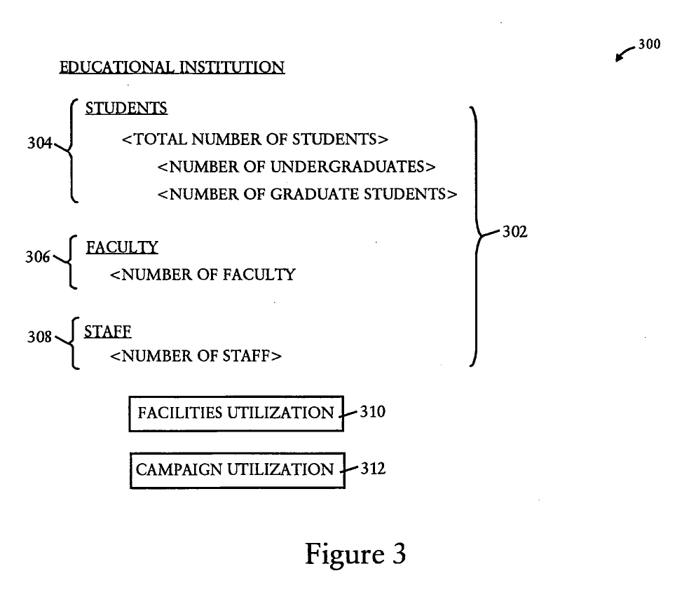

FIG. 3 illustrates an exemplary display 300 that computer system 102 may present to a user (e.g., an administrator or other person using computer 104 or 118, etc.) to provide personal demographic information 302 for an educational institution. For example, personal demographic information 302 for an academic institution may include the number of students 304, number of faculty 306 and number of staff 308 of an educational institution may be presented in display 300. Number of students 304 may further indicate the number of students in a category of students, for example, undergraduate students, graduate students, or any other student designation (e.g., non-traditional students, transfer students, etc.) or number of students by major (e.g., accounting, art, anthropology, architecture, biology, business, chemistry, communications, engineering, English, French, finance, history, music, physics, etc.). Number of faculty 306 may further indicate the number of faculty by each department of the educational institution (e.g., accounting department, art department, anthropology department, architecture department, biology department, business department, chemistry department, communications department, engineering department, English department, foreign languages department, finance department, history department, music department, physics department, etc.). Display 300 may also indicate number of staff 308, which may further indicate the number of staff for each academic department of the institution or affiliated with each facility of the institution. A user of computer 104 and/or 118 may select facilities utilization button 310 in order to view information captured related to the utilization of each facility associated with the educational institution. As described above, the facilities utilization data may be captured by, for example, event registration system 120, post-graduation self-reporting interface 103, etc.

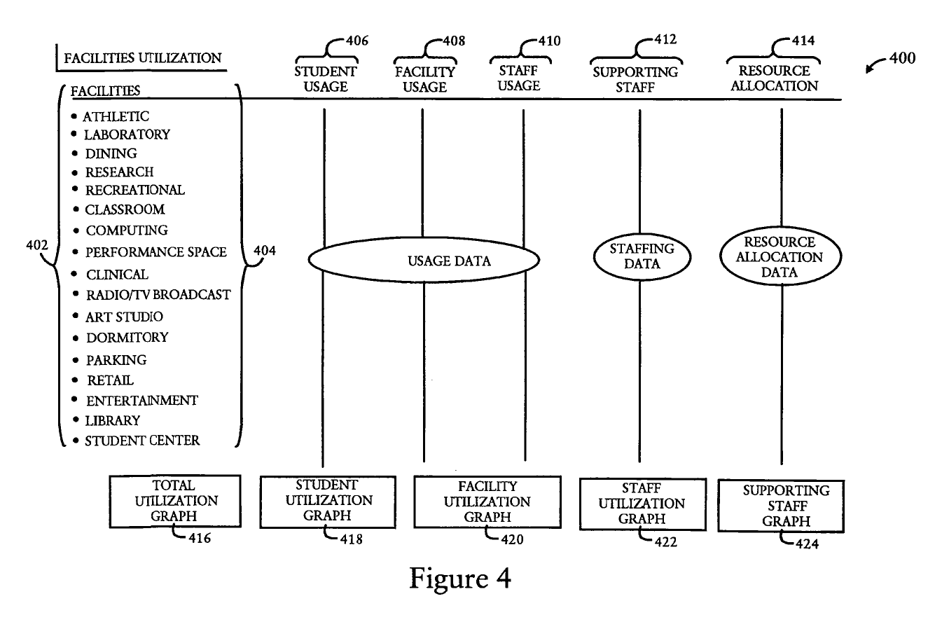

Upon selection of facilities utilization button 310, computer system 102 may present display 400 of FIG. 4, which may illustrate facilities utilization data 402 for one or more facilities 404 of an educational institution, and may further indicate student usage 406, faculty usage 408, staff usage 410, supporting staff 412 (e.g., staff to operate a particular facility), and/or resource allocation 414 which may be the amount of money allocated for the operation and/or maintenance of a particular facility. Facilities 404 may include, but are not limited to athletic facilities, laboratory facilities, dining facilities, research facilities, recreational facilities, classroom facilities, computing facilities, performance space facilities, clinical facilities, radio and television studio broadcast facilities, art studio facilities, dormitory facilities, parking facilities utilization, retail facilities, entertainment facilities, library facilities, student center facilities, or any other suitable facilities, or any combination thereof. The collection of data regarding the usage of the facilities can include data that may be used to determine the nature of the activity in which the facilities are being used. For example, are the tennis courts being used only by tennis players on the team, or are they being used recreationally. Are fields being used by intramural teams, or by unaffiliated groups of participants? Are facilities being used by dormitory-sponsored groups, or by sorority or fraternity groups? This information can be determined by collecting the data related to utilization of facilities by students or other users and checking for common demographic data among the users of the facilities at a given time.

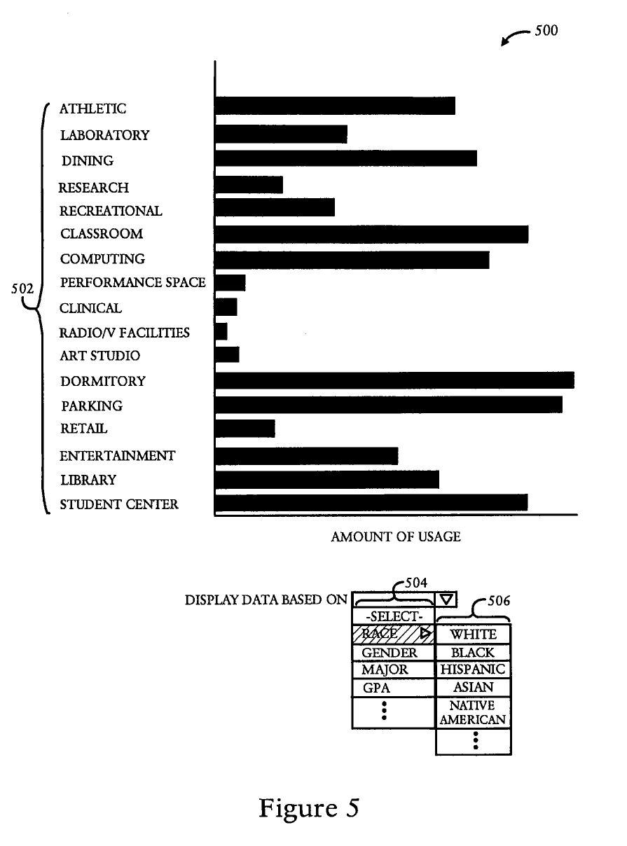

Display 400 may include total utilization graph button 416, student utilization graph button 418, faculty utilization graph button 420, staff utilization graph button 422, supporting staff graph button 424. A user of computer 104 and/or 118 may, for example, select total utilization button 416 and computer system 102 may present display 500 of FIG. 5. Display 500 may be a graphical representation of the utilization data 502 captured indicating the student, faculty and staff usage of one or more facilities of the educational institution. Facilities utilization data may include, but is not limited to: athletic facilities utilization, laboratory facilities utilization, dining facilities utilization, research facilities utilization, recreational facilities utilization, classroom facilities utilization, computing facilities utilization, performance space facilities utilization, clinical facilities utilization, radio broadcast facilities utilization, television studio and broadcast facilities utilization, art studio facilities utilization, dormitory facilities utilization, parking facilities utilization, retail facilities utilization, entertainment facilities utilization, library facilities utilization, or student center facilities utilization, or any combination thereof. FIG. 5 may also include drop down menu 504, which may allow a user to sort or filter the data displayed (e.g., based on race, gender, academic major, grade point average (G.P.A.), financial aid status (e.g., grants, loans, scholarships, etc.), transfer status, housing status, etc.). For example, the user may select to view the data based on race from drop down menu 504. In addition, by using menu 506, a user may further select a racial group (e.g., white, black, Hispanic, Asian, Native American, etc.) to further filter the data for display for utilization data 502. The contents of drop down menu 506 may be based at least in part upon the selection made in drop down menu 504.

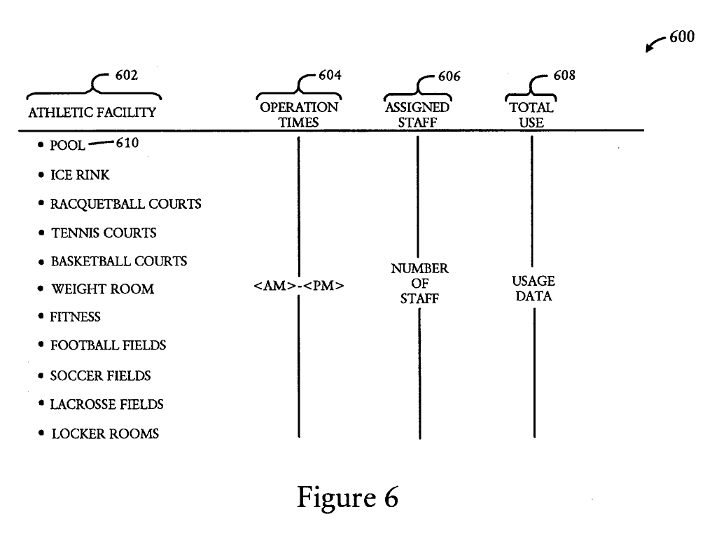

Turning again to display 400 of FIG. 4, a user may also select one or more facilities from facilities 404. For example, a user may select athletic facilities utilization 420, and computer system 102 may present display 600 of FIG. 6. Display 600 may indicate one or more athletic facilities 602 of the educational institution, as well as operational times 604 (e.g., days and times of operation), number of assigned staff 606 (i.e., to support the operation of the facility), and total use 608 (i.e., number of times a particular facility is utilized by students, faculty, staff, administration, or any other person). Athletic facilities 602 of an educational institution may include, but are not limited to: swimming pool, ice rink, racquetball courts, squash courts, tennis courts, basketball courts, weight room, fitness machines (e.g., treadmill, stair climber, etc.), soccer fields, football fields, lacrosse fields, baseball fields, locker rooms, stadiums, or arenas, or any other suitable athletic facility.

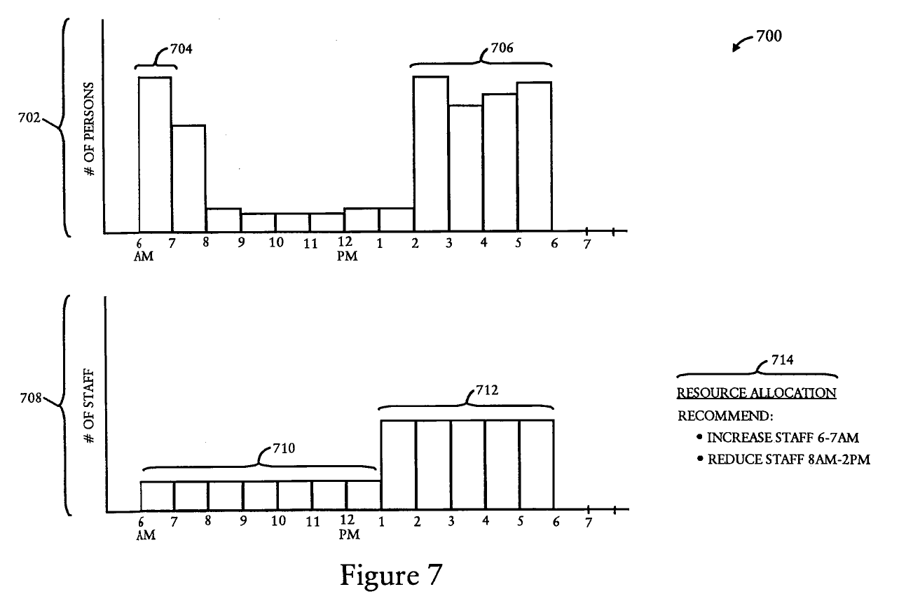

From display 600, a user may select a particular facility in order to obtain captured usage data, staffing of the facility, or any other suitable information, or any combination thereof. For example, a user may select swimming pool 610, wherein computer system 102 may present display 700 of FIG. 7. Display 700 may illustrate graph 702, which may indicate usage of the swimming pool athletic facility during the hours of operation. As shown in exemplary display 700, the swimming pool facility may have experienced the greatest utilization during period 704 (between 6-7 AM), and during period 706 (between 2 PM-6 PM). Additionally, display 700 may present graph 708, that indicates the number of staff associated with the operation of the swimming pool athletic facility during the hours of operation. As indicated in graph 708, the number of staff may be the same in period 710 (e.g., between 6 AM and 1 PM), and then may be increased at period 712 (e.g., at 1 PM, with the staffing remaining the same from 1 PM to 6 PM). Computer system 102 may present recommendation for resource allocation based on usage data. For example, computer system 102 may present recommendation 714 for swimming pool athletic facility 610. Recommendation 716 may indicate that the number of staff be increased 6 AM and 7 AM based on the utilization data indicating comparatively frequent use for this facility. Additionally, computer system 102 may recommend that staff be reduced between 8 AM and 2 PM, as the utilization data for the swimming pool facility indicates comparatively low usage for this particular time period.

It may be of particular interest to educational institutions to employ the disclosed system to determine the demographics of attended events, or the use of facilities. For example, a campaign may be mounted by the education institution to encourage more education in the arts for science majors. The disclosed system is able to determine whether science majors, and more specifically, engineering majors, for example, are attending more concerts in this year than in previous years. And whether those in attendance are exhibiting improved critical thinking skills. Similar data collection and analysis can be performed for other types of demographic groups, such as gender, race, age, major, home state, etc. Armed with this analysis, campaign events can be better tailored to achieve the goals of the institution. Also, institutional resources may be directed to facilities that will be more utilized, or to improve facilities that are under utilized.

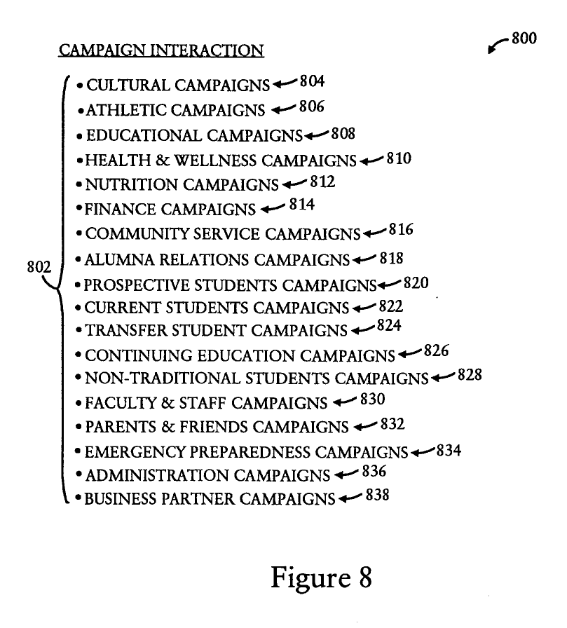

Turning again to display 300 of FIG. 3, a user may utilize computer 104 or 118 to select “campaign utilization button” 312. Upon selection of “campaign utilization” button 312, computer system 102 may present display 800 of FIG. 8. Display 800 may indicate one or more campaigns 802 that an educational institution may have established for members of the institution (e.g., students, faculty, staff, administration, etc.). As shown in exemplary display 800, an educational institution may have campaigns 802 that may include, but are not limited to cultural campaigns 804, athletic campaigns 806, educational campaigns 808, health and wellness campaigns 810, nutrition campaigns 812, finance campaigns 814, community service campaigns 816, alumni relations campaigns 818, prospective student campaigns 820, current student campaigns 822, transfer student campaigns 824, continuing education campaigns 826, non-traditional student campaigns 828, faculty and staff campaigns 830, parents and friends campaigns 832, emergency preparedness campaigns 834, administration campaigns 836, or business partner campaigns 838, or any other suitable campaigns. Such campaigns may, for example, promote educational institutional goals that may include, but are not limited to: encouraging attendance in educational and/or cultural events; stimulating students as lifelong learners; stimulating students for lifelong healthy and active lifestyles; enabling student to think critically; enabling students to communicate their ideas effectively; encouraging on-time graduation; encouraging graduate education; preparing a student for a career in a selected field; encouraging on-time graduation, encouraging participation in alumni events; stimulate lifelong participation in community service and civic activity, etc.

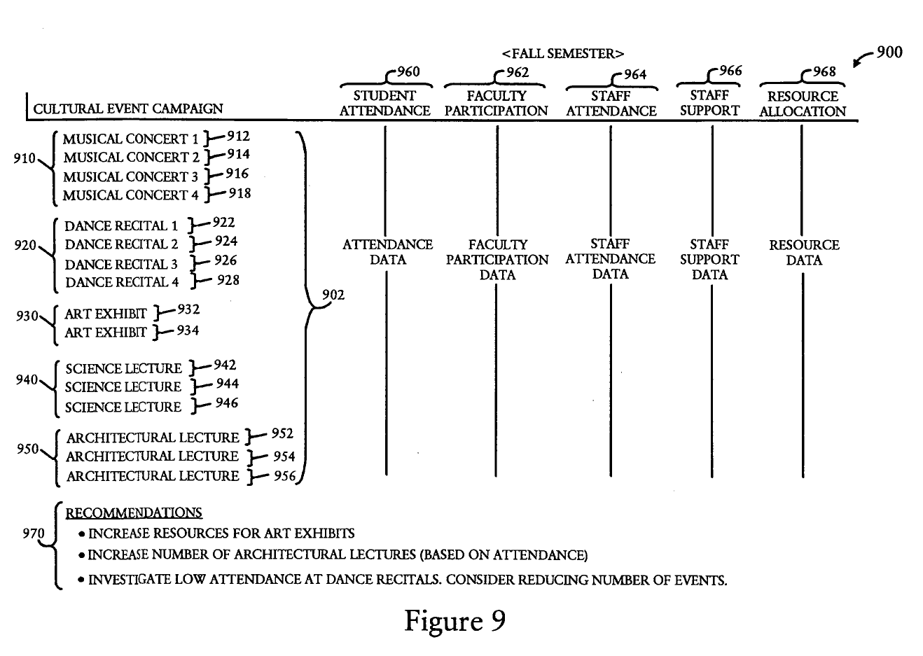

For example, a user of computer 104 or 118 may select cultural campaign 804, and computer system 102 may present display 900 of FIG. 9. Display 900 may indicate events 902 of a cultural event campaign to encourage arts and culture amongst the members of the educational institution (e.g., student members). Events 902 may include musical concerts 910 (e.g., musical concerts 912, 914, 916, 918, etc.), dance recitals 920 (e.g., dance recitals 922, 924, 926, 928, etc.), art exhibits 930 (art exhibits 932, 934, etc.), science lectures 940 (e.g., science lectures 942 and 944, etc.), and architecture lectures 950 (architecture lectures 952, 954, 956, etc.). Also indicated are student attendance 960, faculty attendance 962 (e.g., including faculty attendance and faculty participation), staff attendance 964, staff support 966, and resource allocation 968 (e.g., in dollars or other currency).

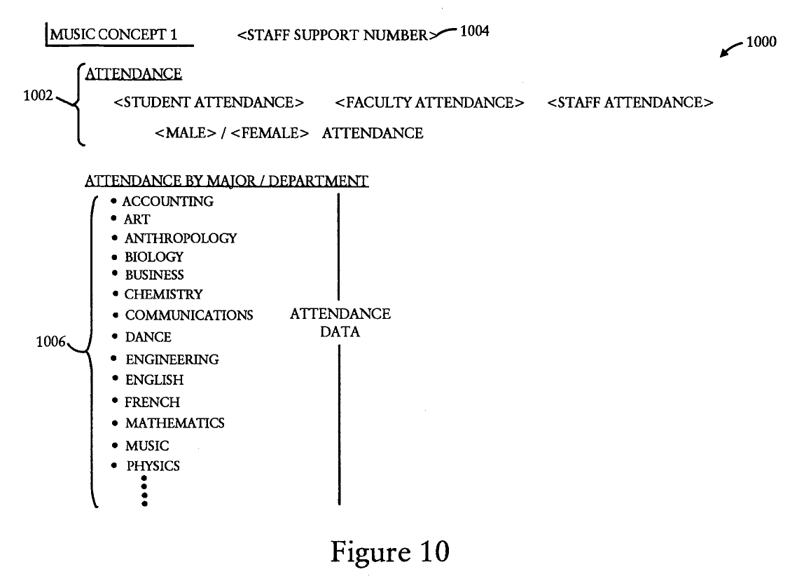

From computer 104 or 118, a user may select, for example, musical concert 912. Computer system 102 may present display 1000 of FIG. 10, which may relate to the campaign interaction data captured by system 100 of FIG. 1 (e.g., by event registration 120, etc.). For example, based on the captured data, display 1000 may indicate attendance number 1002 of male and female students, faculty, and/or staff that attended the musical concert 912. Disproportional demographics at an event may also be discerned and displayed, such as disproportional racial attendance. Display 1000 may also indicate support staff number 1004 present at musical concert 912 to facilitate the event. In addition, attendance number 1002 may further indicate attendee data 1006 the number of student attendees of a particular race, academic year (e.g., freshman, sophomore, junior, senior, graduate student, etc.), or major (e.g., accounting, art, anthropology, architecture, biology, business, chemistry, communications, engineering, English, French, finance, history, music, physics, etc.), or any other suitable category. Display 1000 may also indicate increased or decreased success of the campaign (e.g., cultural event campaign) based on the educational institutional goal (e.g., first year students attend at least three cultural events per semester, etc.) and the interaction data related to the campaign.

Turning again to display 900 of FIG. 9, recommendations 970 may be provided by computing system 102 as to adjustment of resource allocation for events (e.g., musical concert 910, dance recital 920, art exhibit 930, science lecture 940, architectural lecture 950, etc.). For example, computer system may indicate additional resources should be directed towards art exhibits 932 and 934, based on attendance and number of support staff associated with the event. Or, computer system 102 may indicate that the number of architecture lectures (e.g., outside of class) should be increased based on attendance of lectures 932 and 934. In another example, computer system 102 may recommend that the number of dance recitals be reduced based on poor attendance, or that additional money should be allocated to increase the promotion of such events, or that different types of dance performance styles may be selected for future performances.

The detailed description set forth above in connection with the appended drawings is intended as a description of various embodiments and is not intended to represent the only embodiments which may be practiced. The detailed description includes specific details for the purpose of providing a thorough understanding of the embodiments. However, it will be apparent to those skilled in the art that the embodiments may be practiced without these specific details. In some instances, well known structures and components are shown in block diagram form in order to avoid obscuring the concepts of the exemplary embodiments.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for electronically determining utilization of one or more facilities and interaction with campaigns, comprising:
capturing personal interaction data, wherein the personal interaction data has one or more data elements and relates to use of the one or more facilities and interaction with campaigns;
correlating the personal interaction data elements with the one or more facilities and campaigns; and
determining the utilization of the one or more facilities and the interaction with campaigns based at least in part on the correlated personal interaction data elements.

2. The method of claim 1, wherein the capturing personal interaction data comprises reading a swiped card configured with personal data, reading a card configured with personal data with a proximity reader, retrieving personal data stored on an electronic device via a wired or wireless communication interchange, recording a computer login event using personal identifier data, or digitally capturing personal identification information from an electronically submitted communication, or any combination thereof.

3. The method of claim 2, wherein the capturing the personal interaction data comprises capturing facilities utilization data, campaign interaction data, or any combination thereof.

4. The method of claim 3, wherein the capturing of the facilities utilization data indicates athletic facilities utilization, laboratory facilities utilization, dining facilities utilization, research facilities utilization, recreational facilities utilization, classroom facilities utilization, computing facilities utilization, performance space facilities utilization, clinical facilities utilization, radio broadcast facilities utilization, television studio and broadcast facilities utilization, art studio facilities utilization, dormitory facilities utilization, parking facilities utilization, retail facilities utilization, entertainment facilities utilization, library facilities utilization, or student center facilities utilization, or any combination thereof.

5. The method of claim 3, wherein the capturing of the campaign utilization data indicates cultural campaign utilization, athletic campaign utilization, educational campaign utilization, health and wellness campaign utilization, nutrition campaign utilization, finance campaign utilization, community service campaign utilization, alumni relations campaign utilization, prospective student campaign utilization, current student campaign utilization, transfer student campaign utilization, continuing education campaign utilization, non-traditional student campaign utilization, faculty and staff campaign utilization, parents and friends campaign utilization, emergency preparedness campaign utilization, administration campaign utilization, or business partner campaign utilization, or any combination thereof.

6. The method of claim 3, further comprising:
hierarchically categorizing the facilities utilization data and the campaign interaction data;
presenting resource allocation information for each hierarchically categorized facilities utilization data and campaign interaction data.

7. The method of claim 1, further comprising evaluating resource allocation for each of the one or more facilities, campaigns, or facilities and campaigns based at least in part on the determined utilization of the one or more facilities and interaction with campaigns.

8. The method of claim 1, wherein the determining the utilization of the one or more facilities and interactions with campaigns is based at least in part on the correlated personal interaction data elements and further comprises applying factor analysis.

9. A system for electronically determining utilization of one or more facilities and interaction with campaigns, comprising:
a programmable computer configured to:
capture personal interaction data, wherein the personal interaction data has one or more data elements and relates to use of the one or more facilities and interaction with campaigns;
correlate the personal interaction data elements with the one or more facilities and campaigns; and
determine the utilization of the one or more facilities and interaction with campaigns based at least in part on the correlated personal interaction data elements.

10. The system of claim 9, wherein the programmable computer is further configured to receive card swipe data from a card configured with personal data, read a card configured with personal data with a proximity reader, receive personal data stored on an electronic device via a wired or wireless communication interchange, record a computer login event using personal identifier data, or any combination thereof.

11. The system of claim 10, wherein the programmable computer configured to capture the personal interaction data is further configured to capture facilities utilization data or campaign interaction data, or any combination thereof.

12. The system of claim 11, wherein the captured facilities utilization data indicates athletic facilities utilization, laboratory facilities utilization, dining facilities utilization, research facilities utilization, recreational facilities utilization, classroom facilities utilization, computing facilities utilization, performance space facilities utilization, clinical facilities utilization, radio broadcast facilities utilization, television studio and broadcast facilities utilization, art studio facilities utilization, dormitory facilities utilization, parking facilities utilization, retail facilities utilization, entertainment facilities utilization, library facilities utilization, or student center facilities utilization, or any combination thereof.

13. The system of claim 11, wherein captured campaign interaction data indicates cultural campaign interaction, athletic campaign interaction, educational campaign interaction, health and wellness campaign interaction, nutrition campaign interaction, finance campaign interaction, community service campaign interaction, alumni relations campaign interaction, prospective student campaign interaction, current student campaign interaction, transfer student campaign interaction, continuing education campaign interaction, non-traditional student campaign interaction, faculty and staff campaign interaction, parents and friends campaign interaction, emergency preparedness campaign interaction, administration campaign interaction, or business partner campaign interaction, or any combination thereof.

14. The system of claim 11, wherein the programmable computer is further configured to:
hierarchically categorize the facilities utilization data and the campaign interaction data; and
present resource allocation information for each hierarchically categorized facilities utilization data and campaign interaction data.

15. The system of claim 9, wherein the programmable computer is further configured to further comprising evaluating resource allocation for each of the one or more facilities and campaigns based at least in part on the determined utilization of the one or more facilities ad interaction with campaigns.

16. The system of claim 9, wherein the programmable computer configured to determine the utilization of the one or more facilities and interaction with campaigns based at least in part on the correlated personal interaction data elements is further configured to apply factor analysis.

17. Computer readable media containing programming instructions for determining utilization of one or more facilities and interaction with campaigns, that upon execution thereof, causes one or more processors to perform the steps of:
capturing personal interaction data, wherein the personal interaction data has one or more data elements and relates to use of the one or more facilities and interaction with campaigns;
correlating the personal interaction data elements with the one or more facilities and campaigns; and
determining utilization of the one or more facilities and interaction with, campaigns based at least in part on the correlated personal interaction data elements.

18. The computer readable media of claim 17, wherein the capturing personal interaction data comprises reading a swiped card configured with personal data, reading a card configured with personal data with a proximity reader, retrieving personal data stored on an electronic device via a wired or wireless communication interchange, recording a computer login event using personal identifier data, or digitally capturing personal identification information from an electronically submitted communication, or any combination thereof.

19. The computer readable media of claim 18, wherein the capturing the personal interaction data comprises capturing facilities utilization data, campaign interaction data, or any combination thereof.

20. The computer readable media of claim 19, wherein the capturing of the facilities utilization data indicates athletic facilities utilization, laboratory facilities utilization, dining facilities utilization, research facilities utilization, recreational facilities utilization, classroom facilities utilization, computing facilities utilization, performance space facilities utilization, clinical facilities utilization, radio broadcast facilities utilization, television studio and broadcast facilities utilization, art studio facilities utilization, dormitory facilities utilization, parking facilities utilization, retail facilities utilization, entertainment facilities utilization, library facilities utilization, or student center facilities utilization, or any combination thereof.

21. The computer readable media of claim 19, wherein the capturing of the campaign interaction data indicates cultural campaign interaction, athletic campaign interaction, educational campaign interaction, health and wellness campaign interaction, nutrition campaign interaction, finance campaign interaction, community service campaign interaction, alumni relations campaign interaction, prospective student campaign interaction, current student campaign interaction, transfer student campaign interaction, continuing education campaign interaction, non-traditional student campaign interaction, faculty and staff campaign interaction, parents and friends campaign interaction, emergency preparedness campaign interaction, administration campaign interaction, or business partner campaign interaction, or any combination thereof.

22. The computer readable media of claim 19, further comprising:
hierarchically categorizing the facilities utilization data and the campaign interaction data;
presenting resource allocation information for each hierarchically categorized facilities utilization data and the campaign utilization data.

23. The computer readable media of claim 17, further comprising evaluating resource allocation for each of the one or more facilities and campaigns based at least in part on the determined utilization of the one or more facilities and interaction with campaigns.

24. The computer readable media of claim 17, wherein the determining the utilization of the one or more facilities and interaction with campaigns based at least in part on the correlated personal interaction data elements further comprises applying factor analysis.

25. A method for electronically determining resource allocation from student interactions, comprising:
capturing student interaction data, wherein the student interaction data has one or more data elements;
correlating the student interaction data elements with one or more facilities and interaction with campaigns;
determining student usage of the one or more facilities and interaction with campaigns based on the correlated student interaction data elements; and
evaluating the resource allocation for each of the one or more facilities and campaigns based at least in part on the determined student usage.
